(19) United States
(12) Patent Application Publication
(10) Pub. No.: US 2016/0217076 A1
(43) Pub. Date: Jul. 28, 2016

(54) SPECULATIVE CACHE READING USING SHARED BUFFER

(71) Applicant: International Business Machines Corporation, Armonk, NY (US)

(72) Inventors: Deanna P. Berger, Hyde Park, NY (US); Robert J. Sonnelitter, III, Wappingers Falls, NY (US)

(21) Appl. No.: 14/606,048

(22) Filed: Jan. 27, 2015

(51) Int. Cl. G06F 12/08

(52) U.S. Cl. CPC G06F 12/0855; G06F 12/0815; G06F 2212/1041; G06F 2212/507; G06F 2212/621

(57) ABSTRACT

Cache control is provided. A request for ownership of a requested cache line is received from a first processing node. The requested cache line is owned by a second processing node. A coherency message is issued to the second processing node. A shared buffer is caused to store a speculative copy of the requested cache line. Whether a change to the requested cache line occurred is determined. At least one of the requested cache line or the speculative copy is assigned to the first processing node.

### BACKGROUND OF THE INVENTION

The present invention relates generally to the field of improving system performance within a computing environment, and more particularly to speculatively reading a cache using a shared buffer.

A multi-core processor is a single computing component with two or more independent actual central processing units (CPUs) (i.e., cores), which are the processing units that read and execute program instructions. The instructions are ordinary CPU instructions, such as add, move data, and branch, but the multiple cores allow for multiple instructions to be executed at the same time, potentially increasing overall speed. Manufacturers typically integrate the cores onto a single integrated circuit die, or onto multiple dies in a single chip package. Cores may, or may not, share one or more caches.

A cache is a small, fast memory or storage device used to store data or instructions that were accessed recently, are accessed frequently, or are likely to be accessed in the future by a processor. Reading from or writing to a cache is typically cheaper (in terms of access time and/or resource utilization) than accessing other memory or storage devices in a computer system. Once data is fetched from main memory and stored in the cache, the data can be accessed in the cache instead of re-fetching the data from main memory, saving both time and resources. A cache is made up of units of storage referred to as cache lines. Each cache line has a cache line size and an associated cache tag that references the cache line. Data may be fetched from the main memory in units equal to the cache line size for installation in the cache.

### SUMMARY

According to one embodiment of the present invention, a method for cache control is provided. The method includes receiving, from a first processing node, a request for ownership of a requested cache line, wherein the requested cache line is owned by a second processing node; issuing a coherency message to the second processing node; causing a shared buffer to store a speculative copy of the requested cache line; initiating monitoring for changes to the requested cache line; determining whether a change to the requested cache line occurred; and assigning at least one of the requested cache line or the speculative copy to the first processing node.

According to another embodiment of the present invention, a computer program product for cache control is provided. The computer program product comprises a computer readable storage medium and program instructions stored on the computer readable storage medium. The program instructions include program instructions to receive, from a first processing node, a request for ownership of a requested cache line, wherein the requested cache line is owned by a second processing node; program instructions to issue a coherency message to the second processing node; program instructions to cause a shared buffer to store a speculative copy of the requested cache line; program instructions to initiate monitoring for changes to the requested cache line; program instructions to determine whether a change to the requested cache line occurred; and program instructions to assign at least one of the requested cache line or the speculative copy to the first processing node.

According to another embodiment of the present invention, a computer system for cache control is provided. The computer system includes one or more computer processors, one or more computer readable storage media, and program instructions stored on the computer readable storage media for execution by at least one of the one or more processors. The program instructions include program instructions to receive, from a first processing node, a request for ownership of a requested cache line, wherein the requested cache line is owned by a second processing node; program instructions to issue a coherency message to the second processing node; program instructions to cause a shared buffer to store a speculative copy of the requested cache line; program instructions to initiate monitoring for changes to the requested cache line; program instructions to determine whether a change to the requested cache line occurred; and program instructions to assign at least one of the requested cache line or the speculative copy to the first processing node.

### BRIEF DESCRIPTION OF THE DRAWINGS

FIG. 1 is a block diagram of a data processing environment, in accordance with one embodiment of the present invention.

FIG. 2 is a flowchart depicting operations for speculatively reading a cache using a shared buffer, in accordance with an embodiment of the present invention.

### DETAILED DESCRIPTION

Embodiments of the present invention recognize that a cache controller can change ownership of a shared cache line, for example, from one processor or processing core to another. To ensure cache coherency, the cache controller sends a coherency message to the processing unit (PU) that currently owns the cache line and waits for a reply before transferring ownership to the PU requesting ownership. Embodiments recognize that waiting for a reply to the coherency message introduces cache access latency.

Embodiments of the present invention provide reduced cache latency by speculatively reading the cache line using a shared buffer table. Embodiments provide for a cache controller speculatively reading a cache line in response to a request to change ownership of the cache line. The speculatively read cache line is copied to a shared buffer. In response to the cache controller determining that the cache line is coherent, the cache controller transfers access to the PU requesting ownership. In this case, re-accessing the cache is unnecessary. Embodiments of the present invention decrease cache latency by, for example, providing a speculatively read copy of a cache line to a requesting node. Embodiments of the present invention decrease memory traffic by, for example, reducing cache accesses. Embodiments of the present invention reduce power consumption by, for example, reducing cache accesses.

Embodiments of the present invention will now be described in detail with reference to the Figures.

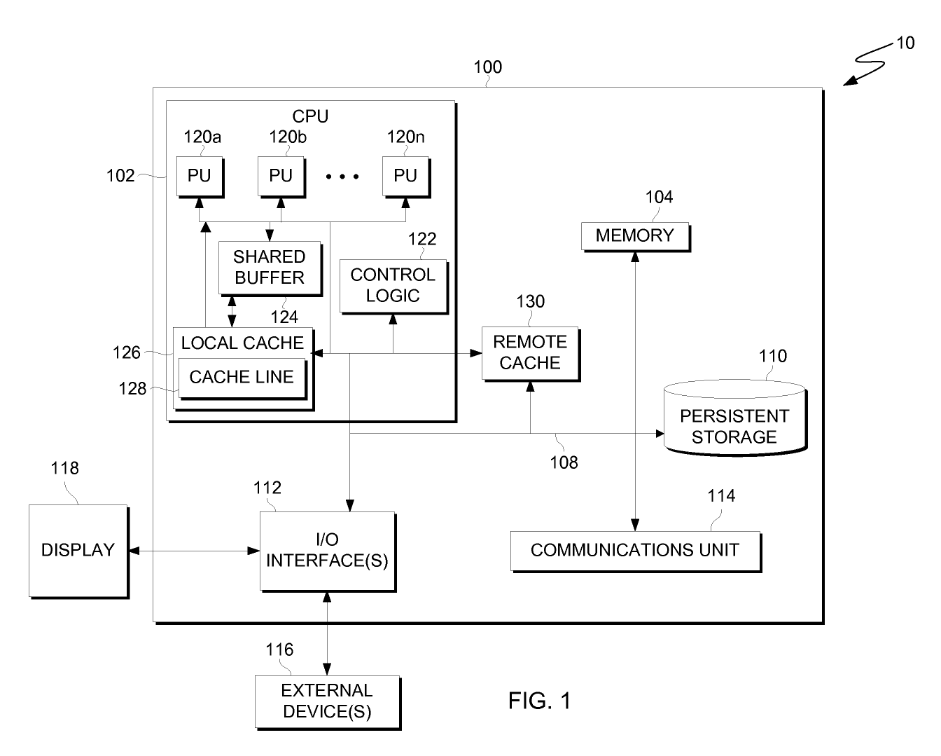

FIG. 1 is a block diagram of a data processing environment, generally designated 10, in accordance with one embodiment of the present invention. FIG. 1 is a block diagram illustrating components of computing device 100, in accordance with one embodiment of the present invention. It should be appreciated that FIG. 1 provides only an illustration of one implementation and does not imply any limitations with regard to the environments in which different embodiments may be implemented. Many modifications to the depicted environment may be made.

In various embodiments, computing device 100 is a computing device that can be a standalone device, a server, a laptop computer, a tablet computer, a netbook computer, a personal computer (PC), or a desktop computer. In general, computing device 100 can be any computing device or a combination of devices capable of executing control logic 122.

Computing device 100 includes CPU 102, memory 104, persistent storage 110, input/output (I/O) interface(s) 112, communications unit 114, remote cache 130, and communications fabric 108. Communications fabric 108 provides communications between CPU 102, remote cache 130, memory 104, persistent storage 110, communications unit 114, and I/O interface(s) 112. Communications fabric 108 can be implemented with any architecture designed for passing data and/or control information between processors (such as microprocessors, communications and network processors, etc.), system memory, peripheral devices, and any other hardware components within a system. For example, communications fabric 108 can be implemented with one or more buses or a crossbar switch.

In one embodiment, CPU 102 is a multi-core processor including PUs 120a through 120n. A multi-core processor is a single computing component with two or more independent actual CPUs (e.g., PU 120a through PU 120n), which are the processing units that read and execute program instructions. CPU 102 includes processing units (PUs) 120a through 120n, control logic 122, shared buffer 124, and local cache 126. Communications fabric 108 provides communication between processing units (PUs) 120a through 120n, control logic 122, shared buffer 124, and local cache 126 in addition to providing communication between CPU 102 and other components of computing device 100. In other embodiments, each PU 120 represents a thread of a processor, in which case CPU 102 is a processor executing a plurality of threads. In general, each PU 120 represents a processing node, which may be a core of CPU 102 or a thread being executed by CPU 102.

PUs 120a through 120n may each be an individual processor located on CPU 102. In general, PUs 120a through 120n share existing communications fabric, such as communications fabric 108, within computing device 100 and data processing environment 10. PUs 120a through 120n may each request data from one or more data sources, such as, for example, local cache 126, remote cache 130, memory 104, or persistent storage 110. Each PU of PUs 120a through 120n may also have additional levels of cache (e.g. L1, L2) located on-chip that are not shared among PUs 120a through 120n, and rather are exclusively accessible and usable by individual PUs of PUs 120a through 120n. In embodiments of the present invention, there may be any number of PUs 120, as indicated by the annotation PUs 120a through 120n. In other embodiments, multiple instances of communications fabric 108 could be used within a CPU, shared by a subset of the total number of PUs 120 on the chip. In general, two or more PUs 120 may exist within CPU 102. As used herein, PU 120 refers to any single PU of PUs 120a through 120n.

Memory 104 and persistent storage 110 are computer readable storage media. In this embodiment, memory 104 includes random access memory (RAM). In general, memory 104 can include any suitable volatile or non-volatile computer readable storage media.

Local cache 126 is a fast memory that enhances the performance of CPU 102 by holding recently accessed data, and data near recently accessed data, from memory 104. Local cache 126 is located on the same integrated circuit die or single chip package as PUs 120a through 120n (e.g., CPU 102). Local cache 126 may be, for example, local L3 cache.

Local cache 126 stores data in units called cache lines, of which cache line 128 is an example. A cache line is the smallest unit of data that can be transferred to or from memory. The size of the cache line varies based on implementation, but example sizes are between thirty-two and one hundred twenty-eight bytes of data. Each cache line is in one of several states that describes whether the data in the cache line is up-to-date. For example, in the MESI cache coherence protocol, the states include modified, exclusive, shared, and invalid.

Remote cache 130 is a fast memory that enhances the performance of CPU 102 by holding recently accessed data, and data near recently accessed data, from memory 104. Remote cache 130 is located off-chip from PUs 120a through 120n (e.g., a location not on CPU 102). Remote cache 130 may be, for example, remote L3 cache, L4 cache, or other off-chip caches.

Shared buffer 124 is a register file located in the on-chip data flow hardware and is used to store data responsive to commands from control logic 122. For example, control logic 122 causes shared buffer 124 to store a copy of cache line 128 responsive to control logic 122 performing a speculative read of cache line 128 from local cache 126.

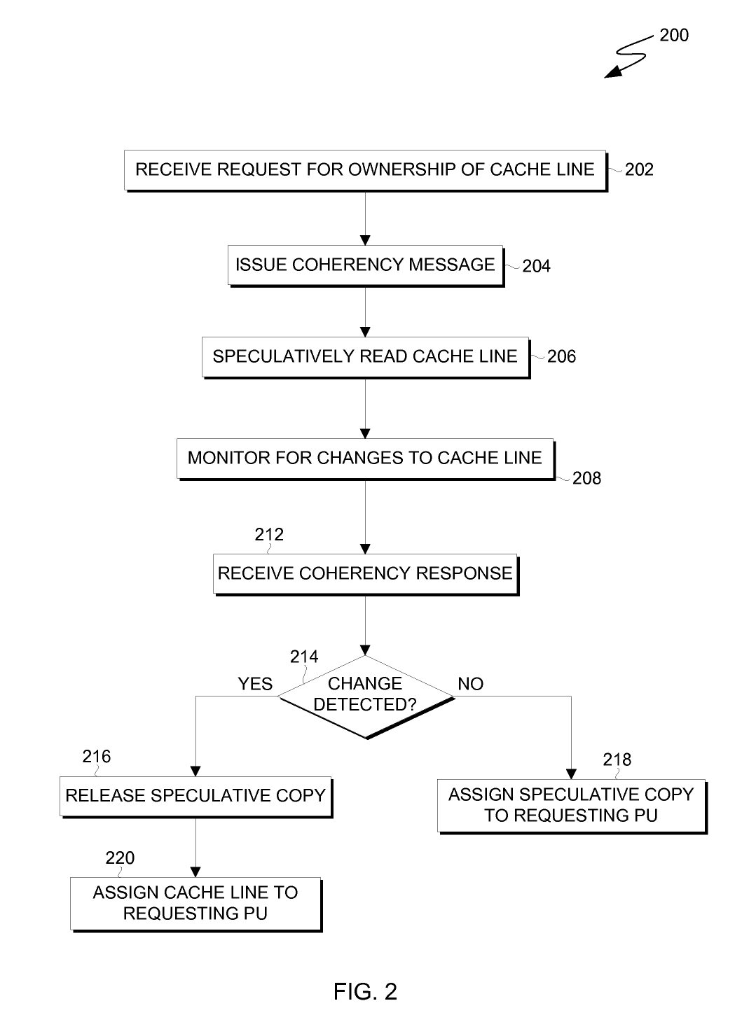

Control logic 122 operates to perform speculative read of cache line 128 of local cache 126 responsive to requests to change ownership of cache line 128. In one embodiment, control logic 122 receives the request to change ownership from a PU 120. For example, the request is a request to change ownership from PU 120a to PU 120b. The operations of control logic 122 are discussed in further detail in connection with FIG. 2.

Programs and data may be stored in persistent storage 110 and in memory 104 for execution by one or more CPUs 102 via one or both of local cache 126 and remote cache 130. In an embodiment, persistent storage 110 includes a magnetic hard disk drive. Alternatively, or in addition to a magnetic hard disk drive, persistent storage 110 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 110 may also be removable. For example, a removable hard drive may be used for persistent storage 110. Other examples include optical and magnetic disks, thumb drives, and smart cards that are inserted into a drive for transfer onto another computer readable storage medium that is also part of persistent storage 110.

Communications unit 114, in these examples, provides for communications with other data processing systems or devices. In these examples, communications unit 114 includes one or more network interface cards. Communications unit 114 may provide communications through the use of either or both physical and wireless communications links. Programs and data may be downloaded to persistent storage 110 through communications unit 114.

I/O interface(s) 112 allows for input and output of data with other devices that may be connected to each computer system. For example, I/O interface(s) 112 may provide a connection to external device(s) 116 such as a keyboard, keypad, a touch screen, and/or some other suitable input device. External device(s) 116 can also include portable computer readable storage media such as, for example, thumb drives, portable optical or magnetic disks, and memory cards. Software and data can be stored on such portable computer readable storage media and can be loaded onto persistent storage 110 via I/O interface(s) 112. I/O interface(s) 112 also connect to display 118.

Display 118 provides a mechanism to display or present data to a user and may be, for example, a computer monitor.

FIG. 2 is a flowchart depicting cache control operations, on a computing device within the computing environment of FIG. 1, in accordance with an embodiment of the present invention. For example, FIG. 2 is a flowchart depicting operations 200 of control logic 122 within data processing environment 10.

In operation 202, control logic 122 receives a request for ownership of a cache line. In one embodiment, the requested cache line is cache line 128 of local cache 126. Control logic 122 receives the request for ownership from a PU of PUs 120. The request for ownership identifies cache line 128, which is owned by a PU 120 of PUs 120. In some embodiments, the PU 120 requesting ownership is a PU 120 other than the PU 120 that currently has ownership. For example, control logic 122 receives, from PU 120a, a request for ownership of cache line 128, which is owned by PU 120b. In various examples, local cache 126 is a shared cache (e.g., shared by at least PU 120a and PU 120b) or an exclusive cache (e.g., exclusive to PU 120b). In other embodiments, the PU 120 requesting ownership is the same PU 120 that currently has ownership. For example, cache line 128 is owned by a first thread of PU 120a and control logic 122 receives, from a second thread of PU 120a, a request for ownership of cache line 128. In this case, control logic 122 issues a coherency message to PU 120a (see operation 204).

In operation 204, control logic 122 issues a coherency message. Control logic 122 issues the coherency message in response to receiving the request for ownership of cache line 128. In one embodiment, control logic 122 issues the coherency message to the PU 120 that owns cache line 128. The coherency message requests that the PU 120 that owns cache line 128 invalidate or demote cache line 128 of local cache 126.

In operation 206, control logic 122 speculatively reads the requested cache line. In one embodiment, control logic 122 speculatively reads cache line 128 in response to the request for ownership of cache line 128. Control logic 122 causes shared buffer 124 to store a copy of cache line 128. Control logic 122 speculatively reads cache line 128 independent of any response to the coherency message issued by control logic 122.

In operation 208, control logic 122 initiates monitoring for changes to the requested cache line. In one embodiment, control logic 122 monitors communications fabric 108 for changes to cache line 128 utilizing bus sniffing (also known as bus snooping). In another embodiment, control logic 122 monitors another bus providing communications between PUs 120 and local cache 126. Control logic 122 monitors for changes to cache line 128 such as, for example, write operations, invalidation, or other operations that change the contents of cache line 128. For example, a PU 120 (e.g., a PU 120 that owns cache line 128) may write data to cache line 128, which changes the contents of cache line 128. Control logic 122 monitors for changes to cache line 128 by comparing the address of the cache line with the address of any other operations flowing through the cache control pipeline that are changing the contents of cache line 128. If the addresses match, control logic 122 detects a change to cache line 128. In some embodiments, control logic 122 monitors for changes to a cache line only while the cache line is stored to shared buffer 124. In this case, control logic 122 maintains a “speculative data in buffer” address compare bit that indicates that a cache line is stored to shared buffer 124 pending a coherency response from the PU 120 that owns the cache line.

In operation 212, control logic 122 receives a coherency response. In one embodiment, the coherency response identifies a state of cache line 128. For example, the coherency response identifies cache line 128 as transferrable or non-transferrable. If the coherency response indicates that cache line 128 is transferrable, then control logic 122 proceeds to decision 214. In one embodiment, control logic 122 ceases monitoring of the requested cache line in response to receiving a coherency response that indicates that cache line 128 is transferrable. If the coherency response indicates that cache line 128 is not transferrable, then control logic 122 re-issues the coherency message (see operation 204). Further, if the coherency response indicates that cache line 128 is not transferrable, control logic 122 may, in one embodiment, retain the speculative copy of cache line 128 in shared buffer 124 and continue to monitor for changes to cache line 128. In another embodiment, if the coherency response indicates that cache line 128 is not transferrable, control logic 122 flushes the speculative copy of cache line 128 from shared buffer 124. In this case, control logic 122 either re-accesses local cache 126 to speculatively read a new copy of the cache line 128 or waits to re-access local cache 126 in response a coherency message indicating that cache line 128 is transferrable.

In decision 214, control logic 122 determines whether changes to the requested cache line have been detected. Control logic 122 detects changes by monitoring for changes to the requested cache line (operation 208). In one embodiment, control logic 122 detects a change based on identifying an operation to write data to the requested cache line. If control logic 122 detects a change to the requested cache line (decision 214, YES branch), then control logic 122 causes shared buffer 124 to release the speculative copy of the requested cache line (operation 216). If control logic 122 detects no changes to the requested cache line (decision 214, NO branch), then control logic 122 assigns the speculative copy to the requesting PU 120 (operation 218).

In operation 216, control logic 122 causes shared buffer 124 to release the speculative copy. In one embodiment, control logic 122 issues an instruction to shared buffer 124 to delete the speculative copy, thereby releasing the storage space previously allocated to the speculative copy.

In operation 218, control logic 122 assigns the speculative copy stored in shared buffer 124 to the requesting PU 120. Control logic 122 assigns the speculative copy of cache line 128 by assigning ownership of the speculative copy to the requesting PU 120. In this case, control logic 122 need not re-access local cache 126 to retrieve an updated copy of cache line 128. In some embodiments, control logic 122 causes local cache 126 to release cache line 128. For example, control logic 122 issues an instruction to local cache 126 to delete cache line 128.

In operation 220, control logic 122 assigns the requested cache line to the requesting PU 120. Control logic 122 assigns cache line 128 to the requesting PU 120 by moving a copy of cache line 128 from local cache 126 to a cache of the requesting PU 120.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for cache control, comprising:
receiving, from a first processing node, a request for ownership of a requested cache line, wherein the requested cache line is owned by a second processing node;
issuing a coherency message to the second processing node;
causing a shared buffer to store a speculative copy of the requested cache line;
initiating monitoring for changes to the requested cache line;
determining whether a change to the requested cache line occurred; and
assigning at least one of the requested cache line or the speculative copy to the first processing node.

2. The method of claim 1, further comprising:
responsive to an earlier of: (i) determining that a content of the requested cache line has changed and (ii) receiving a coherency response in response to the coherency message indicating that the requested cache line is transferrable, ceasing monitoring for changes to the requested cache line.

3. The method of claim 2, further comprising:
responsive to determining a match between an address of the requested cache line and an address of an operation flowing through a cache control pipeline, determining that a change to the requested cache line occurred.

4. The method of claim 3, further comprising:
causing the shared buffer to release the speculative copy of the cache line; and
assigning the requested cache line to the first processing node.

5. The method of claim 2, further comprising:
responsive to receiving a coherency response prior to determining that a change to the requested cache line occurred, determining that no change to the requested cache line occurred, wherein the coherency message indicates that the requested cache line is transferrable.

6. The method of claim 5, further comprising:
responsive to determining that no change to the requested cache line occurred, assigning the speculative copy to the first processing node.

7. The method of claim 5, further comprising:
responsive to determining that no change to the requested cache line occurred, causing a cache of the second processing node to release the requested cache line.

8. A computer program product for cache control, the computer program product comprising:
a computer readable storage medium and program instructions stored on the computer readable storage medium, the program instructions comprising:
program instructions to receive, from a first processing node, a request for ownership of a requested cache line, wherein the requested cache line is owned by a second processing node;
program instructions to issue a coherency message to the second processing node;
program instructions to cause a shared buffer to store a speculative copy of the requested cache line;
program instructions to initiate monitoring for changes to the requested cache line;
program instructions to determine whether a change to the requested cache line occurred; and
program instructions to assign at least one of the requested cache line or the speculative copy to the first processing node.

9. The computer program product of claim 8, wherein the program instructions further comprise:
program instructions to cease monitoring for changes to the requested cache line in response to an earlier of: (i) determining that a content of the requested cache line has changed and (ii) receiving a coherency response in response to the coherency message indicating that the requested cache line is transferrable.

10. The computer program product of claim 9, wherein the program instructions further comprise:
program instructions to determine that a change to the requested cache line occurred in response to determining a match between an address of the requested cache line and an address of an operation flowing through a cache control pipeline.

11. The computer program product of claim 10, wherein the program instructions further comprise:
program instructions to cause the shared buffer to release the speculative copy of the cache line; and
program instructions to assign the requested cache line to the first processing node.

12. The computer program product of claim 9, wherein the program instructions further comprise:
program instructions to determine that no change to the requested cache line occurred in response to receiving a coherency response prior to determining that a change to the requested cache line occurred, wherein the coherency message indicates that the requested cache line is transferrable.

13. The computer program product of claim 12, wherein the program instructions further comprise:
program instructions to assign the speculative copy to the first processing node in response to determining that no change to the requested cache line occurred.

14. The computer program product of claim 12, wherein the program instructions further comprise:
program instructions to cause a cache of the second processing node to release the requested cache line in response to determining that no change to the requested cache line occurred.

15. A computer system for cache control, the computer system comprising:
one or more computer processors;
one or more computer readable storage media;
program instructions stored on the computer readable storage media for execution by at least one of the one or more processors, the program instructions comprising:
program instructions to receive, from a first processing node, a request for ownership of a requested cache line, wherein the requested cache line is owned by a second processing node;
program instructions to issue a coherency message to the second processing node;
program instructions to cause a shared buffer to store a speculative copy of the requested cache line;
program instructions to initiate monitoring for changes to the requested cache line;
program instructions to determine whether a change to the requested cache line occurred; and
program instructions to assign at least one of the requested cache line or the speculative copy to the first processing node.

16. The computer system of claim 15, wherein the program instructions further comprise:
program instructions to cease monitoring for changes to the requested cache line in response to an earlier of: (i) determining that a content of the requested cache line has changed and (ii) receiving a coherency response in response to the coherency message indicating that the requested cache line is transferrable.

17. The computer system of claim 16, wherein the program instructions further comprise:
program instructions to determine that a change to the requested cache line occurred in response to determining a match between an address of the requested cache line and an address of an operation flowing through a cache control pipeline.

18. The computer system of claim 17, wherein the program instructions further comprise:
program instructions to cause the shared buffer to release the speculative copy of the cache line; and
program instructions to assign the requested cache line to the first processing node.

19. The computer system of claim 16, wherein the program instructions further comprise:
program instructions to determine that no change to the requested cache line occurred in response to receiving a coherency response prior to determining that a change to the requested cache line occurred, wherein the coherency message indicates that the requested cache line is transferrable.

20. The computer system of claim 19, wherein the program instructions further comprise:
program instructions, responsive to determining that no change to the requested cache line occurred, to:
assign the speculative copy to the first processing node; and
cause a cache of the second processing node to release the requested cache line.
